(19) United States
(12) Patent Application Publication
(10) Pub. No.: US 2004/0248488 A1
(43) Pub. Date: Dec. 9, 2004

(54) Wallcovering backing fabric

(76) Inventor: Carly P. Tebbetts, Greenville, SC (US)

Correspondence Address: Thomas L. Moses, Legal Department, M-495, PO Box 1926, Spartanburg, SC, 29304, US

(21) Appl. No.: 10/455,021

(22) Filed: Jun. 5, 2003

(51) Int. Cl. B32B 27/12; B32B 5/02; B32B 27/04

(52) U.S. Cl. 442/164; 442/149; 442/208; 442/286; 442/295

(57) ABSTRACT

A wallcovering having a synthetic fabric backing. Generally, the wallcovering includes a top sheet having an adhesively bonded scrim fabric backing substrate that is chemically bonded to the top sheet by a suitable adhesive. The adhesively bonded scrim fabric backing is preferably made of 100% synthetic materials, and includes plural warp yarns crossing plural weft yarns in, either a bi-directional or tri-directional arrangement.

### BACKGROUND OF THE INVENTION

The present invention relates generally to wall coverings, and, more particularly, to a new and improved wall covering having an adhesively bonded scrim fabric backing.

Products such as vinyl wall coverings typically include a fabric substrate that is mechanically attached to the back surface of the wall covering. It is known to use woven fabrics for such fabric backings. For example, gauzes are one type of loosely woven, open-mesh fabric, which are particularly useful in wall covering applications. These fabrics are typically woven from spun yarns made of 100% cellulosic fibers such as cotton or a polyester/cotton blend.

There are several disadvantages to the use of cellulosic fibers, such as cotton. As used herein, “cellulosic fiber” refers to a fiber composed of, or derived from, cellulose. Cellulose is a carbohydrate which is the chief component of the cell walls of plants. It is found in wood and in cotton, linen, jute, hemp, and all of the bast, leaf, and stem fibers. A first disadvantage of these types of fibers is that they tend to have many mechanical sites for bonding, which may result in the absorption or wicking of moisture. As used herein, the term “wicking” refers to the dispersing or spreading of moisture or liquid through a given area, vertically or horizontally. Therefore, cellulosic fibers have an affinity for water, which fosters the growth of mildew and other agents that can be destructive to the wall coverings. Another disadvantage is that spun cellulosic materials are relatively expensive as compared with a gauze formed of continuous multi-filament polymeric yarns such as nylon and polyester, because the steps required in forming a spun yarn contribute to the increase in cost. Spun yarns also tend to include more defects than continuous multifilament yarns. Finally, the cellulosic fiber typically employed, which is cotton, is also a flammable material.

Accordingly, the use of materials that do not contain cellulosic fibers, such as 100% polymeric yarns, in the construction of the fabric is preferable. However, a disadvantage encountered with the use of 100% polymeric yarns in woven fabrics is that they tend to shrink unless the yarns are heat set based on the flexible properties of the yarns.

Therefore, there remains a need for an improved wallcovering having a fabric backing that does not have the limitations and shortcomings of the prior art backings.

### SUMMARY OF THE INVENTION

According to its major aspects and briefly recited, the present invention is a new and improved wallcovering having a fabric backing. Generally, the wallcovering includes a top sheet having an adhesive bonded scrim fabric backing substrate that is chemically bonded to the top sheet by a suitable adhesive. As used herein, “chemically bonded” refers to the joining of two materials by chemical forces such as electrostatic or Van der Waals forces, or by covalent bonding, as opposed joining them mechanically. The adhesively bonded scrim fabric backing is preferably made of 100% synthetic materials, such as polyester, polyamides, polyolefin, ceramic, nylon, fiberglass, basalt, aramid, carbon, or any other suitable polymeric fiber. As used herein, “synthetic materials” refers to any material that requires processing and is not readily available in nature such as cellulose is. In a first embodiment, the backing is a bi-directional, adhesively bonded scrim fabric substrate which includes a plurality of lateral weft yarns that intersect a plurality of warp yarns at right angles and that are bonded at the intersections by an adhesive composition.

In a second embodiment, the fabric substrate includes a tri-directional, also commonly referred to as triaxial, adhesively bonded scrim fabric that is held together by an adhesive composition. As used herein, the term “scrim” means a fabric having an open construction used as a base fabric or a reinforcing fabric. In a triaxial scrim, plural weft yarns having both an upward diagonal slope and a downward diagonal slope are located between plural longitudinal warp yarns that are located on top of the weft yarns and below the weft yarns.

A feature of the present invention is the use of an adhesively bonded scrim fabric backing made of synthetic materials in combination with the wall covering. By using polymeric materials such as polyester for the backing, mildew resistance and fire resistance is improved in the resulting wallcovering as compared to other wallcoverings that employ the use of cotton, or other cellulosic materials. Additionally, the amount of lint and fraying of the fabric backing is reduced by using a fabric comprised of continuous filament yarns instead of a spun yarn fabric.

Other features and advantages of the present invention will be apparent to those skilled in the art from a careful reading of the Detailed Description of the Preferred Embodiments presented below and accompanied by the drawings.

### BRIEF DESCRIPTION OF THE DRAWINGS

In the drawings,

FIG. 1 is a top view of a fabric backing for wallcovering according to a preferred embodiment of the present invention;

FIG. 2 is a perspective view of layers of a wallcovering, including a top sheet and a backing, according to a preferred embodiment of the present invention;

FIG. 3 is a cross-sectional view of a wallcovering according to a preferred embodiment of the present invention; and

FIG. 4 is a top view of a fabric backing for wallcovering according to an alternative embodiment of the present invention.

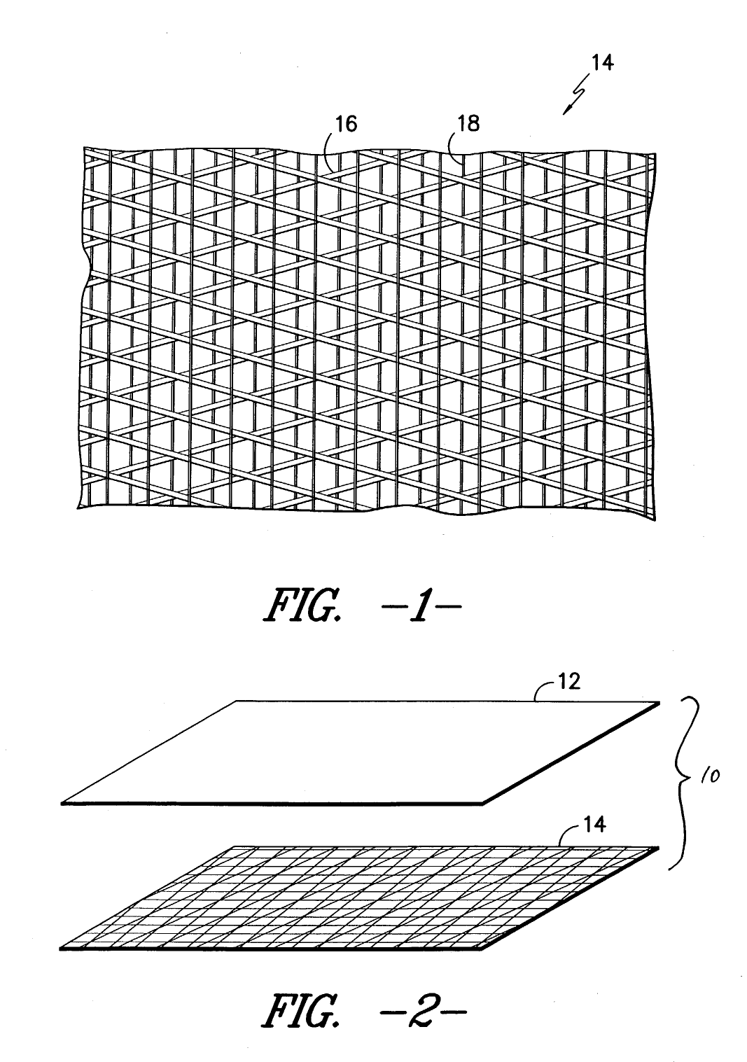

### DETAILED DESCRIPTION OF THE PREFERRED EMBODIMENTS:

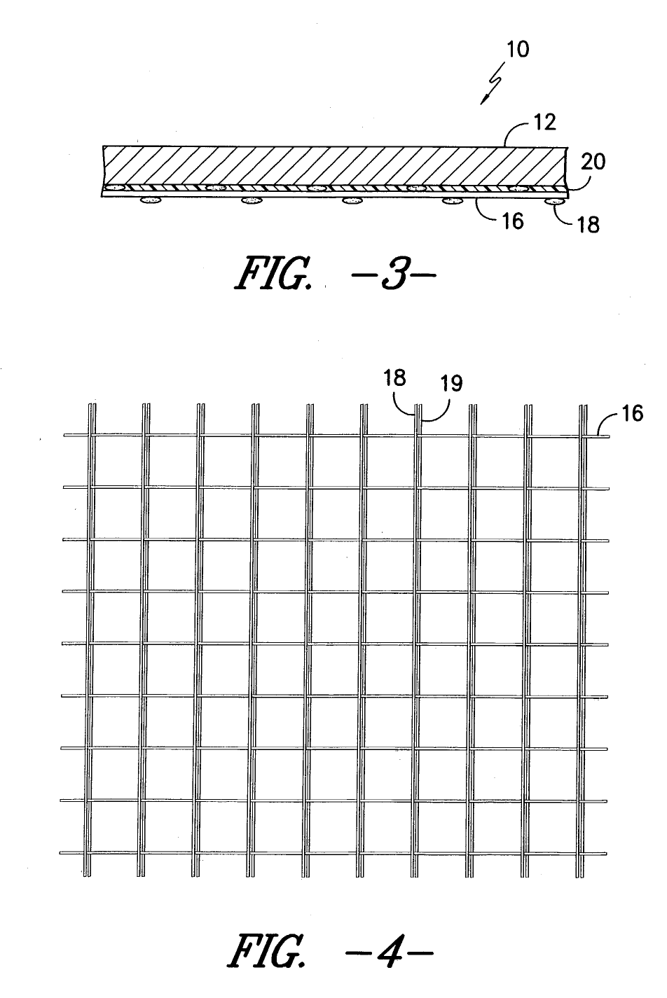

The present invention is a new and improved wallcovering 10 having a fabric backing. As shown in FIGS. 2-3, wallcovering 10 includes a top sheet 12 having a non-woven backing substrate 14. Preferably, top sheet 12 of wallcovering 10 is made of a plastic film, such as vinyl, or a paper material. In a first embodiment, backing substrate 14 of wallcovering is a tri-directional, or triaxial bonded laid scrim fabric that is held together by an adhesive composition, such as polyvinyl alcohol (PVOH), acrylic, polyvinyl acetate, polyvinyl chloride, polyvinylidiene chloride, polyacrylate, acrylic latex or styrenebutadiene rubber (SBR), plastisol, or any other suitable adhesive. As used herein, the term “scrim” shall mean an adhesively bonded non-woven scrim fabric having an open construction used as a base fabric or reinforcing fabric. In a triaxial construction, plural weft yarns 16 having both an upward diagonal slope and a downward diagonal slope are located between plural longitudinal warp yarns 18 that are located on top of the weft yarns 16 and below the weft yarns 16. The preferred range of the fabric construction of the backing substrate 14 is between approximately 8×3×3 (8 ends/inch in the warp direction, and 3 ends per inch on the upward diagonal slope in the weft direction, and 3 ends/inch on the downward diagonal slope in the weft direaction) and 30×10×10, and is most preferably 15×4×4. Further, warp yarns 18 and weft yarns 16 have a preferred denier range of 70 to 1000 denier.

Preferably, weft yarns 16 and warp yarns 18 are made of synthetic materials such as polyester, polyamides, polyolefin, ceramic, nylon, fiberglass, basalt, aramid, carbon fiber, or any other suitable synthetic material. Most preferably, the weft yarns 16 and warp yarns 18 are made of 100% polyester. As previously discussed, a feature of the present invention is the use of adhesively bonded scrim fabric backing 14 made of non-cellulosic materials in combination with the wallcovering 10. By using synthetic materials such as polyester, mildew resistance and fire resistance is improved in the resulting wallcovering as compared to other wallcoverings that employ the use of cotton, or other cellulosic materials. Because materials such as cotton are very villous, they contain many sites for mechanical bonding. Therefore, moisture absorption and wicking can occur wherein liquids travel into the material through capillary action. Further, cotton is a flammable material, which is undesirable in a wallcovering application. Finally, the amount of lint and fraying of the fabric backing 14 is reduced by using a fabric of continuous filament yarns in warp and weft directions instead of a spun yarn fabric.

Backing substrate 14 is heat set using temperatures from 290° F. to 375° F. Advantageously, this temperature range is also used to cure the adhesive used in making the fabric, so that the curing step and the heat setting step may combined into a single step. During the cure of the adhesive, the fabric becomes more stabilized from processing temperature, thus reducing the shrinkage that can occur after the backing 14 is applied to the wallcovering 10.

As shown in FIG. 3, top sheet 12 and fabric backing 14 of wallcovering 10 are joined by an adhesive 20. Preferably, the adhesive 20 used is capable of chemically bonding to both the top sheet 12 material and the fabric backing 14. For example, polyvinyl alcohol could be used as a suitable adhesive 20. Accordingly, a stronger bond is formed between the top sheet 12 and the fabric backing 14 than would be if merely mechanical bonding were employed. The use of chemical bonding, as well as heat setting of the fabric, contributes to the reduction of shrinkage of the backing 14 that can occur. It is more efficient and economical to employ a one-step process for chemically bonding and heat setting the fabric, as set forth herein, than to adhesively bind the fabric in a first step and then heat set it in a second step.

In a second embodiment, backing substrate 14 of wallcovering 10 is a bi-directional, non-woven scrim, which is held together by an adhesive. As shown in FIG. 4, backing substrate 14 includes a layer of parallel weft yarns 16 that are disposed between two convergent layers of parallel warp yarns 18, 19. These yarns are held together by an adhesive, such as polyvinyl alcohol (PVOH), acrylic, polyvinyl acetate, polyvinyl chloride, polyvinylidiene chloride, polyacrylate, acrylic latex or styrene butadiene rubber (SBR), plastisol, or any other suitable adhesive. Preferably, weft yarns 16 and warp yarns 18, 19 are made of synthetic materials such as such as polyester, polyamides, polyolefin, ceramic, nylon, fiberglass, basalt, aramid, carbon fiber, or any other suitable synthetic fiber. Most preferably, the weft yarns 16 and warp yarns 18, 19 are made of 100% polyester. In the preferred fabric construction of the second embodiment, the warp yarns 18, 19 are disposed at approximately 8 to 30 ends per inch, and the weft yarns 16 are disposed at approximately 6 to 30 ends per inch. Further, warp yarns 18, 19 and weft yarns 16 have a preferred denier range of 70 to 1000.

Similar to the first embodiment, backing substrate 14 is heat set using temperatures from 290° F. to 375° F. This temperature range is used to cure the adhesive used in making the fabric. Also similar to the first embodiment, backing substrate 14 is chemically bonded by top sheet 12 by a suitable adhesive 20, such as polyvinyl alcohol.

Those skilled in the art of wallcoverings will recognize that many substitutions and modifications can be made in the foregoing preferred embodiments without departing from the spirit and scope of the present invention.

What is claimed is:

1. A wallcovering, comprising:
a top sheet that is connected to a backing substrate by an adhesive layer, wherein said backing substrate includes plural weft yarns bonded to plural warp yarns, and wherein said warp yarns and said weft yarns are made of a synthetic fiber.

2. The wallcovering as recited in claim 1, wherein said top sheet is made of a material selected from a group consisting of plastic, vinyl, and paper.

3. The wallcovering as recited in claim 1, wherein said adhesive layer is made of polyvinyl alcohol.

4. The wallcovering as recited in claim 1, wherein said warp yarns and said weft yarns are bonded together by an adhesive.

5. The wallcovering as recited in claim 4, wherein said adhesive is selected from a group consisting of polyvinyl alcohol, polyvinyl acetate, styrene butadiene rubber, polyvinyl chloride, polyvinylidene chloride, plastisol, polyacrylate, acrylic latex, and any combinations thereof.

6. The wallcovering as recited in claim 1, wherein said backing substrate is bi-directional.

7. The wallcovering as recited in claim 6, wherein said weft yarns are disposed at 6 to 20 ends per inch and said warp yarns are disposed at 8 to 30 ends per inch.

8. The wallcovering as recited in claim 6, wherein said weft yarns and said warp yarns range from approximately 70 to 1000 denier.

9. The wallcovering as recited in claim 1, wherein said backing substrate is tri-directional.

10. The wallcovering as recited in claim 9, wherein said backing substrate has a fabric construction of 4 to 18 ends per inch in the warp direction and between 3×3 and 10×10 ends per inch in the weft direction.

11. The wallcovering as recited in claim 1, wherein said synthetic fiber is selected from a group consisting of polyester, polyamides, polyolefin, ceramic, nylon, fiberglass, basalt, aramid, and carbon fiber.

12. The wallcovering as recited in claim 1, wherein 100% of said backing substrate is made of said synthetic material.

13. A method for making a wallcovering, comprising:
providing a top sheet;
providing a backing substrate having plural weft yarns bonded to plural warp yarns, said weft yarns and said warp yarns being made of a synthetic material;
adhering said top sheet to said backing substrate.

14. The method as recited in claim 13, wherein said synthetic material is selected from a group consisting of polyester, polyamides, polyolefin, ceramic, nylon, fiberglass, basalt, aramid, and carbon fiber.

15. The method as recited in claim 13, wherein said backing substrate is bi-directional.

16. The method as recited in claim 13, wherein said backing substrate is tri-directional.

17. The method as recited in claim 13, wherein said plural weft yarns and said plural warp yarns are bonded by an adhesive selected from a group consisting of polyvinyl alcohol, polyvinyl acetate, styrene butadiene rubber, polyvinyl chloride, polyvinylidene chloride, plastisol, polyacrylate, acrylic latex, and any combinations thereof.

18. A wallcovering, comprising:
a top sheet that is connected to a backing substrate by an adhesive layer, wherein said backing substrate includes plural weft yarns bonded to plural warp yarns by an adhesive selected from the group consisting of polyvinyl alcohol, polyvinyl acetate, styrene butadiene rubber, polyvinyl chloride, polyvinylidene chloride, plastisol, polyacrylate, acrylic latex, and any combinations thereof, and wherein said warp yarns and said weft yarns are made of 100% polyester.

19. The wallcovering as recited in claim 18, wherein said backing substrate is bi-directional.

20. The wallcovering as recited in claim 18, wherein said backing substrate is tri-directional.
